(19) United States
(12) Patent Application Publication
(10) Pub. No.: US 2012/0296804 A1
(43) Pub. Date: Nov. 22, 2012

(54) System and Methods for Producing a Credit Feedback Loop

(76) Inventors: Aaron B. Stibel, Malibu, CA (US); Jeffrey M. Stibel, Malibu, CA (US); Judith Gentile Hackett, Malibu, CA (US); Moujan Kazerani, Santa Monica, CA (US); Jeremy Loeb, Santa Monica, CA (US)

(21) Appl. No.: 13/475,377

(22) Filed: May 18, 2012

Related U.S. Application Data
(60) Provisional application No. 61/487,565, filed on May 18, 2011.

(51) Int. Cl. G06Q 40/02

(52) U.S. Cl. 705/38

(57) ABSTRACT

Some embodiments provide a credit feedback loop system that directly identifies credit that is available to a credit seeker based on recent credit that others with similar qualifications (e.g., credit scores) as the credit seeker have obtained. The credit feedback loop system establishes a reciprocal system to benefit credit providers and credit seekers. The credit providers participate by providing information about the credit they have recently extended to credit seekers. In return, the credit feedback loop system acts as a lead generation platform for the credit providers by identifying potential new credit seekers. A credit seeker benefits by obtaining a direct and accurate measure of its available credit without having to divulge confidential information. In so doing, the credit feedback loop system allows a credit seeker to accurately identify its available credit and be quasi-preapproved for credit without having to apply for credit from any single credit provider.

### CLAIM OF BENEFIT TO RELATED APPLICATIONS

This application claims the benefit of U.S. provisional application 61/487,565, entitled “System and Methods for Producing a Credit Feedback Loop”, filed May 18, 2011. The contents of the provisional application 61/487,565 are hereby incorporated by reference.

### TECHNICAL FIELD

The present invention pertains to a system, methods, and software products for determining credit availability and creditworthiness.

### BACKGROUND

Individual credit scores and business credit scores are well established metrics from which financial institutions and other transactional partners gauge risk and determine the likelihood that an individual or business will meet its debt obligations. An individual's credit score or personal credit is quantified by the FICO® score. A business' credit score is most commonly quantified by the Paydex® score developed by Dun & Bradstreet. These credit scores are enumerated for exemplary purposes. However, the description below is applicable to other forms of individual credit scores and business credit scores (e.g., VantageScore® and NextGen Score).

FICO scores are derived from various factors affecting an individual's personal financial history. These factors include payment history, amount of leveraged credit, length of credit history, and other such factors. FICO scores are standardized to range between values of 300-850. A value of 850 is representative of the lowest likelihood in the scale that an individual will go past due on his/her debt obligations. Credit providers use FICO scores and/or other personal credit scores to determine the amount of credit to extend to an individual, whereby credit is extended in the form of credit cards, home mortgage loans, property rental, personal credit lines, personal loans, and the like. Accordingly, a credit provider is defined to include a bank, a credit card company, a financing company, and any other lender involved in the business of lending based on FICO scores and/or Paydex scores.

Paydex scores are primarily derived by determining the promptness with which businesses pay their suppliers and creditors. Paydex scores are standardized to range between values of 0-100. A value of 100 is representative of a business that submits all payments on time or before they become due. Credit providers use Paydex scores to determine the amount of credit to extend to a business. Credit may be extended to a business in the form of credit cards and lines of credit as some examples.

Any individual or business can obtain its credit score from one or more credit reporting agencies. Individual credit scores can be obtained from companies such as Experian, Equifax, and TransUnion; business credit scores can be obtained from companies such as Dun & Bradstreet. However, a fundamental and inherent problem with the credit score is its lack of tangible and real-world significance for the individual or business for which the credit score is derived. Stated differently, the credit score of a first entity is an informational vehicle for a second entity that is determining whether or not to engage in a transaction or relationship with the first entity, instead of serving as an informational vehicle for the first entity. For example, a Paydex score of 80 can be a “very good” score and identify that a particular business for which the score is derived is one that has a very low risk of defaulting on its debt obligations. For the particular business, the score, in and of itself, has no direct value in that it does not directly identify new opportunities, it does not directly increase revenue, and it does not directly identify the creditworthiness of the particular business. Instead, the Paydex score of 80 can be used, for example, by suppliers to determine what terms to offer the particular entity and can be used by others to determine what kind and how much credit to the particular business. The business therefore has no actual knowledge of what forms of credit or how much credit it can obtain solely based on its credit score without first shopping the credit score around to others. This is because the credit reporting agencies that derive the credit scores are separate and distinct from the credit lenders that extend credit based on the credit scores. The credit lenders use their own unpublished and proprietary algorithms to ascertain how much credit to lend to an individual or a business based on a credit score of the individual or business. Without access to these algorithms, a credit seeker has no way to decipher from its credit score how much credit is available to it. Moreover, the same credit score may be evaluated differently based on different credit dimensions such as the industry or profession in which the credit seeker is in. Further still, a common occurrence in the determination and evaluation of small business credit is to use a business credit score in conjunction with personal credit scores. As a result, credit scores are indeterminate measures of creditworthiness and provide no tangible and real-world significance for the individuals or businesses for which the credit scores are derived. As used hereafter, a credit seeker refers to any entity, whether an individual or business, that is in need of credit and for which a credit score has been derived by a credit reporting agency.

Therefore, in order to derive a tangible and real-world significance from the credit scores, individuals or businesses blindly shop around their credit scores to various credit lenders in order to independently ascertain their true creditworthiness. To do so, an individual or business goes from one credit provider to another, fills out different credit applications, awaits results that specify different credit amounts and terms, and then selects the credit provider that offers the best amounts and terms of credit. Clearly, this process is inefficient and wastes the time and resources of both the credit seekers and the credit providers.

Certain systems and methods have been established to simplify the identification of the credit that is available to a credit seeker. However, these systems and methods usually involve the credit seeker filling out an application or other form that is then submitted to multiple different credit providers for terms or for approval. For instance, each credit provider runs the credit seeker provided information through their proprietary algorithms to determine whether or not they are willing to extend credit and how much credit to extend to that credit seeker. The results from each credit provider are then aggregated and provided to the credit seeker. This process does not produce immediate results, exposes the credit seeker to the credit providers, and simply converts a manual process into an automated process. In other words, such a process requires the credit seeker to apply for credit from the various credit providers, before the credit providers reveal what kind of credit and how much credit they are will to extend to the credit seeker. Credit seekers often shy away from such processes and systems because they do not want the credit providers to obtain the credit seekers' confidential information. In this model, a credit seeker is essentially applying for credit from a credit provider before knowing the terms and rates of the credit provider. Credit seekers may also shy away from such processes and systems because they do not want to undertake the time consuming task of completing the application and awaiting the results of the application before formally obtaining credit from a specific credit provider.

Other systems and methods utilize proprietary algorithms apart from the algorithms of the credit providers to estimate the credit that various credit providers are likely to make available to a credit seeker having a particular credit score. This available credit information is often unreliable and inaccurate as it is not derived directly from the credit providers' algorithms and is not based on what the credit providers have actually lent.

Lastly, some systems and methods create a credit marketplace. In some manifestations, the marketplace allows credit seekers that meet certain requirements to bid for credit that is made available from different credit providers. In some other manifestations, the marketplace allows credit seekers to list the credit they need and terms they are seeking for such credit and credit providers can the bid to offer such credit on the stated terms or on better terms.

Accordingly, there is a need to attribute some tangible or real-world significance to credit scores so that individuals and businesses can easily, readily, and accurately ascertain the credit that is available to them without undergoing additional steps of completing applications and revealing confidential information to the credit providers. There is a further a need to leverage the use of credit scores in a manner that better meets the objectives of banks, lenders, and other credit providers.

### SUMMARY OF THE INVENTION

It is an object of the present invention to define a system, methods, and computer software products for deriving direct and real-world significance from credit scores to facilitate improved and more efficient extension of credit from credit providers to credit seekers. It is further an object to simplify and streamline the process of applying for and obtaining credit by bridging the divide that exists between credit reporting agencies, credit seekers, and credit providers. It is further an object to present actual amounts of credit that are available to a credit seeker from various credit providers without the credit seeker having to apply for credit from any one or more credit providers.

To achieve these and other objects, some embodiments implement a credit feedback loop system. The credit feedback loop system directly identifies credit that is available to a credit seeker based on recent credit that others with similar qualifications as the credit seeker have recently obtained. In some embodiments, the qualifications include credit scores. In this manner, the credit seeker need not provide any additional confidential information to credit providers or fill out applications other than to provide the credit score or information from which the credit feedback loop system can obtain the credit score of the credit seeker from a credit reporting agency.

To obtain the information regarding the credit that others have recently obtained from credit providers, the credit feedback loop system establishes a reciprocal system to benefit credit providers and credit seekers that participate in the credit feedback loop. In some embodiments, credit providers make available to the credit feedback loop system, information about the credit they have recently extended to various credit seekers while retaining confidentiality of the credit seekers. For example, a credit provider divulges to the credit feedback loop system an amount of credit extended, terms for the credit, and the credit score of the credit seeker that obtained the credit. In return, the credit feedback loop system acts as a lead generation platform for the credit providers, wherein leads are generated without the credit providers engaging in costly marketing or advertising. More specifically, the credit feedback loop system identifies potential new credit seekers to the credit providers. Also, by aligning the qualifications of a potentially new credit seeker with the qualifications of previous credit seekers that have successfully obtained credit from a particular credit provider, the credit feedback loop system performs a quasi-preapproval of each generated lead. In some embodiments, the credit providers control their participation in the credit feedback loop system by setting thresholds to specify minimum requirements for the leads that are generated. This provides for a more thorough quasi-preapproval of the credit seekers, thereby increasing the likelihood that a generated lead will be able to successfully obtain credit from a particular credit seeker. As a result, the credit feedback loop system saves both credit seekers and credit providers time and resources, thereby promoting a more efficient marketplace for identifying and obtaining credit.

A credit seeker benefits from such a credit feedback loop system because the credit seeker is able to obtain a direct and accurate measure of its available credit quickly and without having to divulge confidential information beyond a credit score. In contrast to existing systems and methods for obtaining credit, the credit feedback loop system allows the credit seeker to obtain a direct and accurate measure of its available credit without having to directly interact with any credit provider and without having to fill out and submit credit applications to the credit providers simply to obtain available credit and terms from the credit providers. A further benefit to the credit seeker is that the credit feedback loop system saves the credit seeker time and effort by presenting only the credit that is likely available to the credit seeker such that the credit seeker can avoid unnecessarily submitting credit applications to credit providers that will not lend to the credit seeker. Stated differently, the credit feedback loop system allows a credit seeker to accurately identify its available credit and be quasi-preapproved for credit without having to apply for credit from any single credit provider. A further advantage of the credit feedback loop is that it provides a single interface from which a credit seeker can readily identify and obtain different types of available credit from different credit providers. Such an interface empowers the credit seeker by allowing the credit seeker to comparatively analyze the credit that is available at each of the different credit providers from a single interface.

When a credit seeker identifies a credit provider that the credit seeker is quasi-preapproved to obtain credit from, the credit feedback loop system simplifies and improves the manner with which the credit seeker applies for credit from that particular provider. In some embodiments, the credit feedback loop enables the credit seeker to remotely apply for credit at one or more credit providers without the credit seeker having to travel to or directly communicate with the credit providers and by automatically filling out different applications on behalf of the credit seeker. In some embodiments, a common credit application form is provided by the credit feedback loop system such that the credit seeker fills out one instance of the credit application form and that credit application form can be submitted to multiple credit providers. Some embodiments permit credit providers to upload custom credit application forms. In some embodiments, these custom forms can then be automatically populated from data that is provided to the common credit application.

In some embodiments, the credit feedback loop system is implemented with a data aggregator, a data matcher, a database, and a user interface. The data aggregator aggregates credit origination data from one or more credit providers and stores the aggregated data to the database. Additionally, the data aggregator may aggregate credit origination data directly from the credit seekers that have successfully obtained credit from the credit provider. The credit origination data specifies (1) amounts and terms of credit that has been extended by the one or more credit providers and (2) associated identification information. The associated identification information may include the credit scores for the credit seekers that obtained the credit or may include other identifiers such as a name, address, a telephone number, Data Universal Numbering System (DUNS®) number, employer identification number (EIN), etc. It should be apparent to one of ordinary skill in the art that the confidentiality of the credit seekers can be maintained when the associated identification information includes credit scores and not the names, addresses, telephone numbers, etc. of the credit seekers.

From this aggregated data, the system identifies the credit that is available to new applicants seeking credit. This identification is accomplished by the data matcher. The data matcher associates a credit score with each piece of aggregated credit origination data. When the identification information that is associated with credit origination data is not a credit score but a name, telephone number, etc., the data matcher uses the identification information to query an entity database in order to identify an entity record that contains additional information about the entity that is represented by the identification information. The data matcher automatically obtains a credit score for the represented entity. The data matcher associates the credit score with the aggregated credit origination data and the credit origination data and associated credit score are stored back to the database.

When a new credit seeker requests to identify its available credit, the data matcher obtains identification information about the credit seeker. The identification information is provided using the user interface. The credit seeker may provide its credit score, but oftentimes the credit seeker is unaware of its credit score or the credit score that it is aware of may be outdated. Therefore, the credit seeker can instead provide basic identification information such as the credit seeker's first and last name, business name, address, telephone number, etc.

The identification information is used to perform entity matching against the database. As a result, the data matcher obtains an entity record that contains additional previously verified information about the credit seeker. The data matcher leverages the information from the entity record to obtain a credit score of the credit seeker. In some embodiments, the credit score is present in the entity record. In some embodiments, the information from the entity record is used to query a credit reporting agency to obtain the credit score. The data matcher then uses the obtained credit score of the credit seeker to identify a subset of credit origination data from the database, wherein the subset of credit origination data identifies credit origination data that other credit seekers with the same or similar credit score have obtained from one or more credit providers. In some embodiments, the subset of credit origination data is further filtered based on additional credit dimensions specified by the credit seekers, credit providers, or credit feedback loop system administrator. The resulting subset of credit origination data is then processed to identify credit that is available to the applicant. In summary, available credit for the credit seeker is identified based on credit that other similarly qualified credit seekers have obtained.

The user interface presents the available credit to the credit seeker. The user interface provides interactivity from which the credit seeker can identify the available credit offered by different credit providers and interactivity with which the credit seeker can be directly referred to or can directly apply for credit from one or more of the presented credit providers.

In some embodiments, the credit feedback loop system generates revenue by restricting access to the available credit information to those credit seekers that pay to access the data. In some other embodiments, the credit feedback loop system generates revenue based on referral fees for referring credit seekers to credit providers that then extend credit to the credit seekers based on the referral.

### BRIEF DESCRIPTION OF THE DRAWINGS

In order to achieve a better understanding of the nature of the present invention a preferred embodiment of the credit feedback loop system and methods will now be described, by way of example only, with reference to the accompanying drawings in which:

FIG. 1 conceptually illustrates the credit feedback loop that results from the system and methods of some embodiments.

FIG. 2 illustrates various components of the credit feedback loop system in accordance with some embodiments.

FIG. 3 presents a process performed by the data matcher to match aggregated credit origination data to a credit score in accordance with some embodiments.

FIG. 4 conceptually illustrates the data matcher matching aggregated credit origination data to a credit score in accordance with some embodiments.

FIG. 5 presents a process performed by the data matcher to identify available credit for a new credit seeker in accordance with some embodiments.

FIG. 6 conceptually illustrates the data matcher identifying available credit for a new credit seeker in accordance with some embodiments.

FIG. 7 provides an exemplary user interface for interactively presenting credit available to a particular credit seeker in accordance with some embodiments.

FIG. 8 conceptually illustrates how different credit dimensions can be used to filter the credit availability data that is presented in the user interface in accordance with some embodiments.

FIG. 9 illustrates a user interface with which a credit provider can set filters in accordance with some embodiments.

FIG. 10 presents a process for producing credit indices in accordance with some embodiments.

FIG. 11 conceptually illustrates performing the process to derive a first credit availability index and a second credit availability index in accordance with some embodiments.

FIG. 12 illustrates a computer system with which some embodiments are implemented.

### DETAILED DESCRIPTION OF THE INVENTION

In the following detailed description, numerous details, examples, and embodiments of a credit feedback loop system and methods are set forth and described. As one skilled in the art would understand in light of the present description, the system and methods are not limited to the embodiments set forth, and the system and methods may be practiced without some of the specific details and examples discussed. Also, reference is made to accompanying figures, which illustrate specific embodiments in which the invention can be practiced. It is to be understood that other embodiments can be used and structural changes can be made without departing from the scope of the embodiments herein described.

Certain terminology is defined to facilitate the discussion below. The term credit seeker includes any entity that seeks to ascertain its available credit. The credit seeker may do so for the purpose of acquiring credit or for the purpose of inquiring as to its creditworthiness. A credit seeker includes either an individual or a business (i.e., an agent that acts on behalf of the business). A credit seeker may also include a first entity that seeks to ascertain the available credit for a second different entity. However, some embodiments may restrict access such that an entity is only able to access its own available credit data and not that of others. The functionality, application, and examples of the credit feedback loop system and methods will be primarily described with reference to credit seekers that are small businesses. This is not intended as a limitation or to be restrictive. Accordingly, when the discussion is directed to small business credit seekers, it should be apparent to one of ordinary skill that the functionality, application, and examples are similarly applicable to other credit seekers (e.g., individuals, large businesses, etc.).

A credit provider includes any bank, lender, or other financial institution that is involved in the origination or lending of credit. Credit may be originated in various different forms such as credit cards, home mortgage loans, property rental, personal credit lines, personal loans, and the like.

A credit reporting agency is involved in determining the creditworthiness of different entities. A credit reporting agency usually quantifies the creditworthiness of a particular entity as a score. For instance, the quantification may include credit scores such as FICO scores and Paydex scores. However, other scores or metrics may be used by the credit reporting agency to quantify entity credit. The credit reporting agency may generally quantify credit or may specifically quantify a particular type of credit (e.g., credit risk, mortgage financing, automobile financing credit, creditworthiness at a particular business, etc.). Some examples of credit reporting agencies include Experian, Equifax, TransUnion, and Dun & Bradstreet.

Credit origination data refers to the credit that was obtained by a credit seeker from a credit provider. Credit origination data identifies the amounts and terms of the obtained credit. Credit terms may include interest rates, duration of a loan, payment schedule, and/or other factors that specify the conditions related to the extended credit.

I. Overview

Ordinarily, a credit seeker interacts with one or more credit providers and credit reporting agencies in order to determine what types of credit and how much credit are available to it. Specifically, the credit reporting agencies supply the credit score for the credit seeker. In and of itself, the credit score provides no direct insight into the credit that is available to the credit seeker. Accordingly, the credit seeker shops the credit score around to the various credit providers. The credit providers utilize the credit score as a variable into proprietary algorithms from which the amount and terms of available credit are identified and then presented to the credit seeker. Therefore, in order for the credit seeker to comparatively analyze the credit that is available to it, the credit seeker interacts with different credit providers by filling different credit applications or by shopping its credit score to multiple credit providers. Because of this closed manner with which credit providers operate, the task of determining available credit using prior art systems and methods is time consuming, tedious, and inefficient. Moreover, the credit seeker has no idea whether a particular credit provider would extend any credit to the credit seeker until the credit seeker divulges various confidential information about itself to that particular credit provider by means of completing and submitting a credit application to the particular credit provider.

To overcome these inefficiencies and to provide a more efficient marketplace in which to ascertain one's available credit and to obtain that available credit, some embodiments implement a credit feedback loop system. The credit feedback loop system provides a particular credit seeker direct access to its actual available credit based on credit origination data of other credit seekers that have successfully obtained credit and that have similar qualifications as the particular credit seeker. One such qualification is based on the credit score (e.g., FICO, Paydex, etc.), wherein similarity between the credit score of the particular credit seeker and the credit scores of the other credit seekers that have successfully obtained credit are used to identify the credit that is available to the particular credit seeker. Consequently, the credit seeker is able to immediately identify what types of credit and how much credit is available to it from multiple credit providers without the inefficiencies related to filling out and submitting different credit application forms to different credit providers.

The credit feedback loop system is established on the basis of reciprocity to provide incentive to both credit providers and credit seekers and to encourage their participation in the credit feedback loop system. A credit provider participating in the credit feedback loop system makes its credit origination data available to the credit feedback loop system and in return receives leads for quasi-preapproved credit seekers that meet certain qualifications of the credit provider. A credit seeker participating in the credit feedback loop obtains a direct and accurate measure of its available credit from various credit providers without having to divulge confidential information beyond a credit score and without having to directly interact with any of the credit providers by filling out and submitting credit applications to the credit providers. Also, by identifying credit that was successfully obtained by others with similar qualifications as the credit seeker, the credit feedback loop system facilitates a quasi-preapproval of the credit seeker to increase the likelihood that the credit seeker can actually obtain the credit that is presented as available.

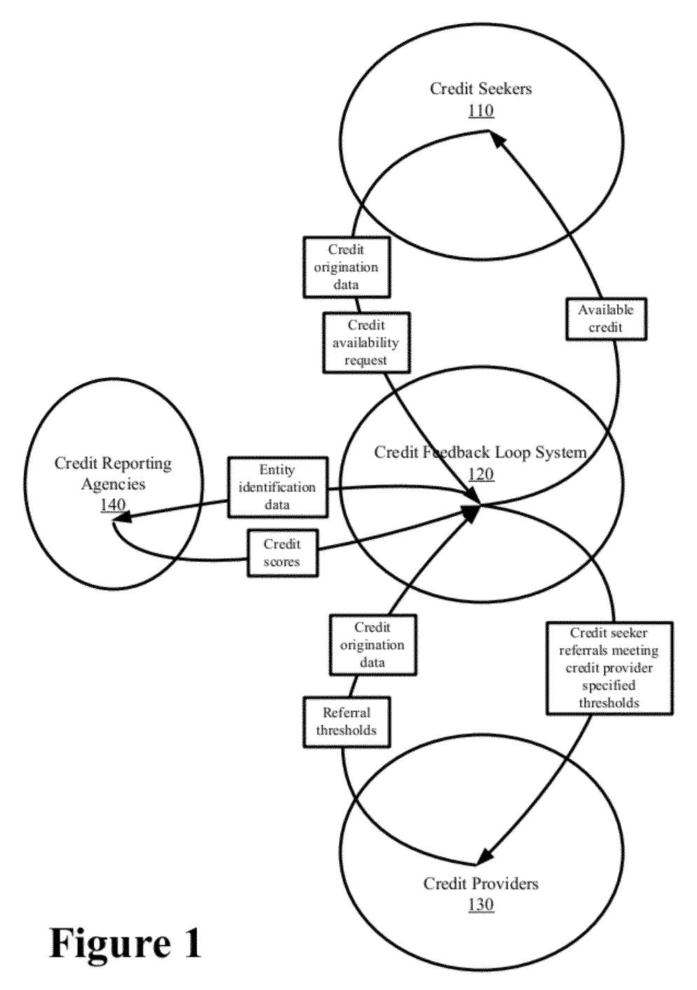

FIG. 1 conceptually illustrates the credit feedback loop that results from the system and methods of some embodiments. As shown, the credit feedback loop involves credit seekers 110, the credit feedback loop system 120, credit providers 130, and credit reporting agencies 140.

The credit feedback loop is established based on credit origination data that the credit feedback loop system 120 aggregates from the various credit providers 130 and credit seekers 110 participating in the credit feedback loop. The credit feedback loop system 120 provides automated and manual mechanisms from which to aggregate credit origination data from the credit providers 130 and/or the credit seekers 110. The credit origination data identifies amounts and terms of credit that credit providers 130 have extended to various credit seekers 110. Each instance of aggregated credit origination data is associated with a credit score, wherein the associated credit score is the credit score of the entity that successfully obtained the type of credit, amount of credit, and terms of credit specified by the credit origination data.

Collectively, the aggregated credit origination data creates a recent record of the credit that the credit providers 130 have extended to various credit seekers 110. The credit feedback loop system 120 uses this recent record to identify available credit for a new credit seeker. To do so, the credit feedback loop system 120 obtains a credit score for the new credit seeker. In some embodiments, the new credit seeker provides its credit score to the credit feedback loop system 120. In some embodiments, the new credit seeker provides at least one identifier to identify itself to the credit feedback loop system 120. The credit feedback loop system 120 then uses the provided identifier to obtain an entity record containing additional identifying information about the new credit seeker. The additional identifying information is passed from the credit feedback loop system 120 to the credit reporting agency 140 in order to obtain a credit score for the new credit seeker. Next, the credit feedback loop system 120 uses the obtained credit score of the new credit seeker to identify a subset of the aggregated credit origination data that is then presented as the credit that is available to the new credit seeker. Specifically, the subset of credit origination data identifies the types of credit, amounts, and terms of credit that previous credit seekers with the same or similar credit score as the new credit seeker have recently obtained. Accordingly, the subset of credit origination data is an accurate and recent indication of the types of credit, amounts, and terms of credit that is available to the new credit seeker. For example, the credit feedback loop system 120 aggregates credit origination data from multiple credit providers that 120 credit seekers within the past month having a Paydex credit score ranging between 78-82 have obtained, on average, a $25,000 loan at 7% interest and a credit card with a $10,000 line of credit at 10% interest. Accordingly, when a new credit seeker with the Paydex credit score of 80 inquires as to its available credit, the credit feedback loop system 120 can directly and accurately report those values as available credit.

The credit feedback loop system 120 completes the loop between the credit seekers 110 and the credit providers 130 by allowing the credit seekers 110 to directly apply for credit that is available from one or more of the credit providers 130. In some embodiments, the credit feedback loop system 120 provides a user interface through which available credit from different credit providers is presented to a credit seeker. The user interface provides interactive links that direct the credit seeker to a selected credit provider. As part of the direction, some embodiments of the credit feedback loop system 120 automatically populate a credit application of the selected credit provider based on previously provided information by the credit seeker. A benefit of the credit feedback loop system 120 is that prior to being redirected to a selected credit provider, the credit seeker will have been quasi-preapproved as a result of identifying to the credit seeker the credit that other credit seekers having similar qualifications (e.g., credit scores) as the credit seeker have successfully obtained from the redirected to credit provider.

In some embodiments, the credit providers 130 control their participation in the credit feedback loop and the leads that the credit feedback loop system 120 refers to the credit providers 130. To do so, the credit providers 130 set thresholds that specify minimum qualifications for the credit seekers that are referred to the credit providers by the credit feedback loop system 120. For example, a credit provider may specify a threshold that restricts the credit seeker leads that are generated by the credit feedback loop system 120 to include only credit seekers with a Paydex credit score of 75 or above. Continuing with this example, the threshold causes the credit feedback system 120 to hide the available credit of that credit provider from credit seekers that have a credit score of 74 or lower.

In some embodiments, the reporting of the available credit by the credit feedback loop system 120 is accomplished without having the credit seeker know or provide its credit score. Similarly, the reporting of the available credit is accomplished without the traditional time consuming process of having to fill out different credit applications for different credit providers. Rather, the credit seeker provides one or more identifiers readily known to the credit seeker (e.g., name, address, telephone number, address, URL, DUNS number, EIN, social security number, etc.) and the credit feedback loop system 120 automatically obtains the credit score for the seeker. Using the obtained credit score, the credit feedback loop system 120 identifies available credit based on the credit that other similarly qualified credit seekers have recently obtained from multiple credit providers (and for which credit origination data has been aggregated into the system 120). As a result, the new credit seeker is able to view the types of credit, amounts, and terms of credit that each of several credit providers has offered to similarly qualified credit seekers and be quasi-preapproved for such credit because of the similar qualifications that the new credit seeker shares with other credit providers. The credit seeker can comparatively analyze the credit made available by the different credit providers without having to apply for credit from any one of the credit providers.

II. Credit Feedback Loop System

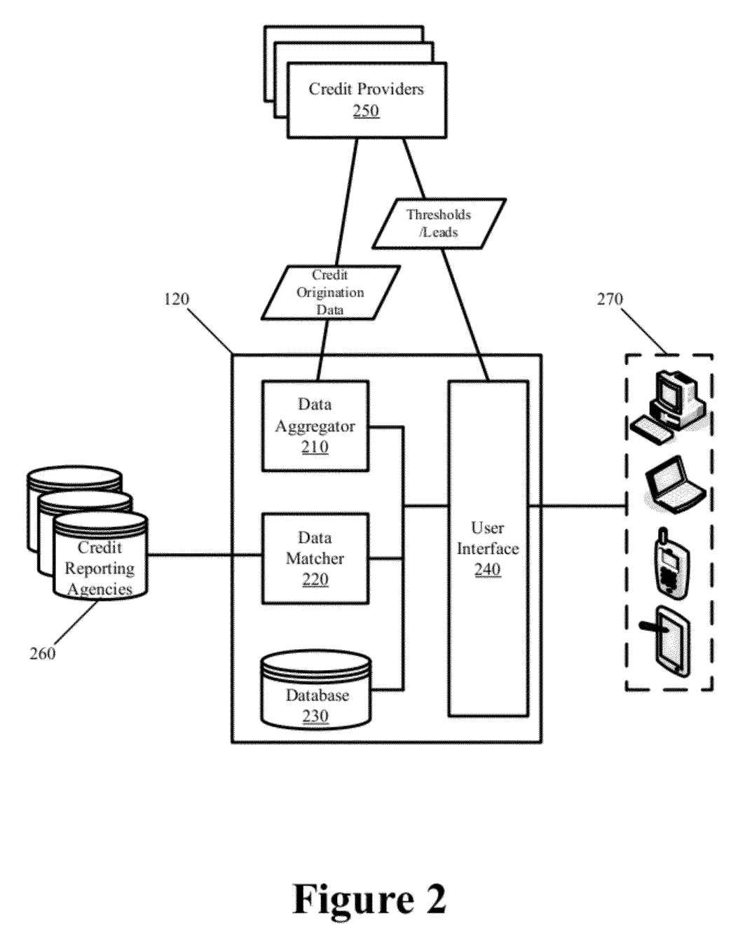

FIG. 2 illustrates various components of the credit feedback loop system 120 in accordance with some embodiments. As shown, the credit feedback loop system 120 includes data aggregator 210, data matcher 220, database 230, and user interface 240. FIG. 2 further depicts credit providers 250, credit reporting agencies 260, and credit seekers 270 that are communicably coupled to one or more of the components 210-240 of the credit feedback loop system 120.

Some or all of the credit feedback loop system 120 components 210-240 are embodied as software applications or processes that are stored to a non-transitory computer-readable storage medium and that execute on one or more physical computing devices. The components 210-240 may execute on a single physical machine that is adapted to perform the functionality of each of the data aggregator, data matcher 220, database 230, and user interface 240. Alternatively, the components 210-240 may execute on two or more machines, either virtual or physical, wherein the collective set of machines operate to perform the functionality of the credit feedback loop system 120. Accordingly, the components 210-240 act to transform one or more general purpose computers or electronic hardware to one or more specific purpose machines that utilize the aggregated credit origination data to produce various tangible assets that provide further insight into the credit that is available to an entity. Some such assets include reports and/or interfaces to identify the credit that is available to the entity at various credit providers, quasi-preapproving the entity for credit of the various credit providers, automatically completing credit application forms on behalf of the entity and automating the application submission process, and the credit seeker leads that the credit feedback loop system provides to the credit providers. It should therefore be apparent that the processes described below for producing these assets are preferably computer-implemented processes.

A. Data Aggregator

In some embodiments, the data aggregator 210 is tasked with collecting credit origination data from the credit providers 250 and the credit seekers 270. To collect credit origination data from the credit providers 250, the credit feedback loop system 120 first establishes partnerships with the credit providers 250. The partnerships allow the data aggregator 210 to directly interface with and obtain credit origination data from the databases or servers of the credit providers 250. In some embodiments, the partnerships are established on the basis of reciprocity, whereby the credit providers 250 provide access to their credit origination data and in return, the credit feedback loop system 120 provides new credit seeker referrals to the credit providers 250. Partnerships may be established by other means as well. For example, partnerships may be established on the basis of a revenue sharing model. In such a model, a portion of the revenue that is generated by the credit feedback loop system 120 as a result of having access to the credit origination data of the credit providers 250 is shared with the credit providers 250.

Once a partnership is established with a particular credit provider of the set of credit providers 250, the data aggregator 210 interfaces with that particular credit provider using a network protocol such as the Internet Protocol (IP), Secure Shell (SSH) Protocol, File Transparent Protocol (FTP), etc. In some such embodiments, the particular credit provider configures a secure login comprising a username and password with which the data aggregator 210 can securely connect to the database of the particular credit provider. Once connected to the particular credit provider database, data crawling scripts or processes of the data aggregator 210 generate an automated feed whereby credit origination data is automatically pulled from the database to the data aggregator 210 over the network. Depending on the credit provider, the credit origination data may identify new lines of credit, business loans, credit cards, etc. In some embodiments, the particular credit provider pushes updated credit origination data to the data aggregator 210 on a periodic basis or as the updated credit origination data becomes available.

In some embodiments, the credit origination data aggregated by the data aggregator 210 includes at least two components. The first component includes credit data specifying the type of credit, amount, and terms of credit that have been extended to a particular credit seeker. The credit terms may include an interest rate and duration as some examples. However, credit terms may vary depending on the type of credit. As one example, the first component identifies a home mortgage loan in the amount of $250,000 with 5% interest over 15 years. The second component of the aggregated credit origination data includes at least one identifier. The at least one identifier directly or indirectly identifies the credit score of the credit seeker that successfully obtained the credit identified by the corresponding first component of the credit origination data. In some embodiments, the second component is the credit score (e.g., Paydex score, FICO score, etc.) for the credit seeker that successfully obtained the credit identified by the corresponding first component of the credit origination data. In such instances, the actual identity of the credit seeker is withheld from the credit feedback loop system 120 and only the credit score of that credit seeker is revealed by the credit provider to the credit feedback loop system 120. Alternatively, the second component of the credit origination data may include one or more of a name, telephone, address, URL, DUNS number, EIN, social security number, and other such identifiers that partly identify who the credit seeker is. As will be discussed below, the identifiers are used by the data matcher 220 to automatically lookup a credit score for the entity that is represented by the one or more identifiers and to associate that credit score to the identifier.

In some embodiments, the data aggregator 210 tags the incoming credit origination data to associate the identity of the credit provider from which the credit origination data was aggregated. The tag may include an identifier (e.g., name or numerical value) that uniquely identifies the credit provider from which credit origination data is obtained. Such tagging allows the credit feedback loop system 120 to subsequently identify which credit providers have extended what types of credit, amounts, and terms of credit. As a result, the credit feedback loop system 120 is able to direct new credit seekers to the appropriate credit provider.

In some embodiments, the data aggregator 210 obtains credit origination data from the credit seekers 270. In some such embodiments, the credit seekers 270 access the user interface 240 in order to submit to the credit feedback loop system 120, credit origination data for credit that they have recently obtained. Specifically, the credit seekers 270 identify the type, amounts, and terms of credit that they were able to obtain and the credit provider from which the credit was obtained. Additionally, the credit seekers 270 provide (1) their credit scores to associate with the submitted credit origination data or (2) basic identification information from which the data matcher 220 can identify the credit score for the credit seekers 270 in order to then associate the credit score with the submitted credit origination data.

In some embodiments, the credit feedback loop system 120 automatically obtains credit origination data by acting as a broker or lead generation platform for the credit providers 250. When the credit feedback loop system 120 refers a credit seeker 270 to a credit provider 250 and the credit seeker 270 successfully obtains credit from the credit provider 250, the credit feedback loop system can broker the transaction and thereby automatically aggregate the credit origination data. Alternatively, the credit feedback loop system 120 may have a contractual agreement with the credit providers 250 which obligates the credit providers 250 to report credit origination data to the credit feedback loop system 120 for credit that the credit providers 250 provide to any credit seekers that were referred by the credit feedback loop system 120.

The data aggregator 210 continually runs to aggregate the most recent credit origination data from the credit providers 250 and credit seekers 270. The aggregated credit origination data is stored to the database 230 where it is processed by the data matcher 220.

B. Data Matcher

The data matcher 220 is tasked with matching aggregated credit origination data to a credit score. The data matcher 220 is also tasked with identifying a credit score for each new credit seeker. In so doing, new credit seekers can be matched to the aggregated credit origination data along a single variable, the credit score.

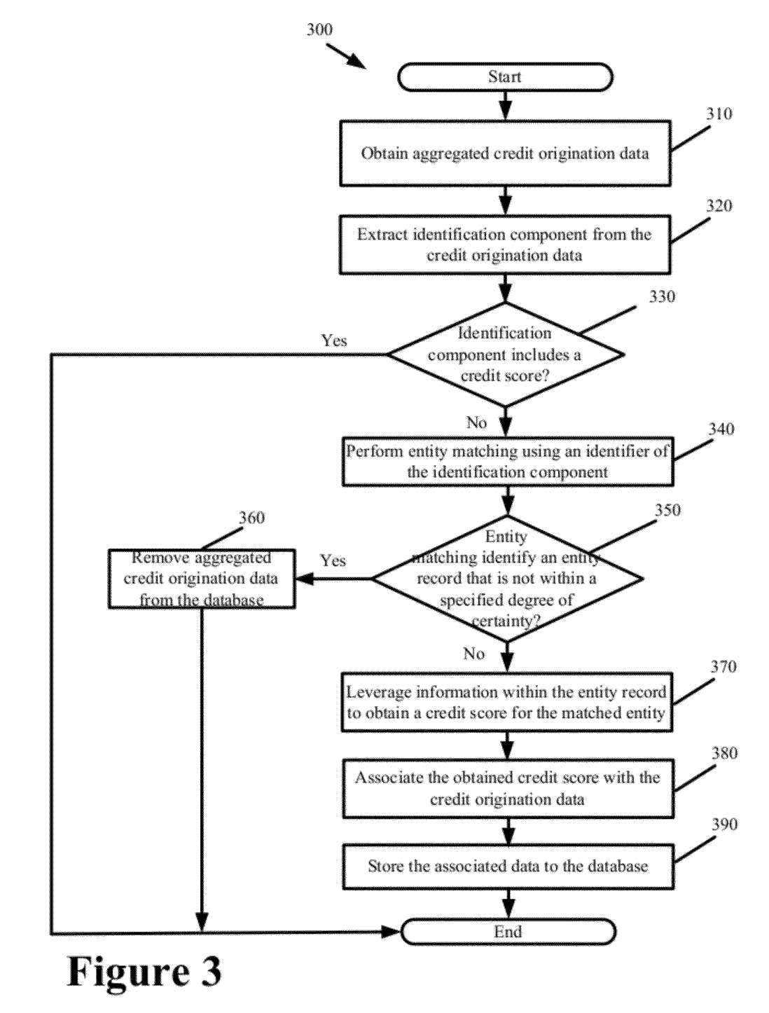

FIG. 3 presents a process 300 performed by the data matcher 220 to match aggregated credit origination data to a credit score in accordance with some embodiments. The process 300 begins when the data matcher 220 obtains (at 310) aggregated credit origination data from the credit feedback loop system database 230 or from the data aggregator 210. This may occur periodically or as the credit origination data is aggregated.

The process extracts (at 320) the second identification component from the credit origination data. The process determines (at 330) whether the second identification component includes a credit score. When the second identification component includes a credit score, no further matching is performed by the data matcher 220 and the process restarts by selecting the next piece of aggregated credit origination data or the process ends. However, when the second identification component does not include a credit score, but one or more other identifiers, the data matcher uses the identifiers to perform (at 340) entity matching.

Entity matching is performed (at 340) by querying an entity database using the one or more identifiers of the second identification component. The entity database may be integrated into the database 230 or may be maintained by an independent third party such as Dun & Bradstreet or other credit reporting agency. The entity database stores individual and business entity records. Each entity record contains aggregated information about an individual or business. Some such information includes identification information such as a name, address, telephone number, domain name, etc. Additionally, the information may include other information such as financial information (e.g., stock pricing, revenue, and sales) and employee information as some example. Dun & Bradstreet maintains and updates a business entity database that contains detailed information for over 200,000,000 businesses. The data matcher 220 uses the identifiers of the second identification component to identify one or more entity records from the entity database with a degree of certainty. Entity matching is successful when the identifiers identify a particular entity record with a specified degree of certainty (e.g., greater than 90% certainty). For example, when the identifier includes just an address, entity matching may identify five distinct entities that are associated with that address, each with a 20% degree of certainty. However, when the identifier includes an address and a telephone number, entity matching may identify a single entity with a 95% degree of certainty. Accordingly, the process determines (at 350) whether the entity matching has identified an entity record within the specified degree of certainty.

When an entity record cannot be identified within the specified degree of certainty, the process removes (at 360) the aggregated credit origination data from the database 230 or otherwise suspends the data and the process restarts with different credit origination data or the process ends. Otherwise, the process leverages (at 370) information within the entity record to obtain a credit score for the matched entity. In some embodiments, the credit score is included as part of the entity record. In some other embodiments, the information within the entity record is used to perform a subsequent query to one or more credit reporting agencies that provide credit scores for individuals or businesses. For example, the data matcher parses an entity record to submit a query containing the name, address, telephone number, and DUNS number for a business to a Paydex credit reporting agency. Established partnerships with credit reporting agencies 260 allow the data matcher 220 to obtain the credit scores when needed.

Upon obtaining the credit score, the process associates (at 380) the credit score to the aggregated credit origination data. The credit score and the aggregated credit origination data are stored (at 390) back to the database 230.

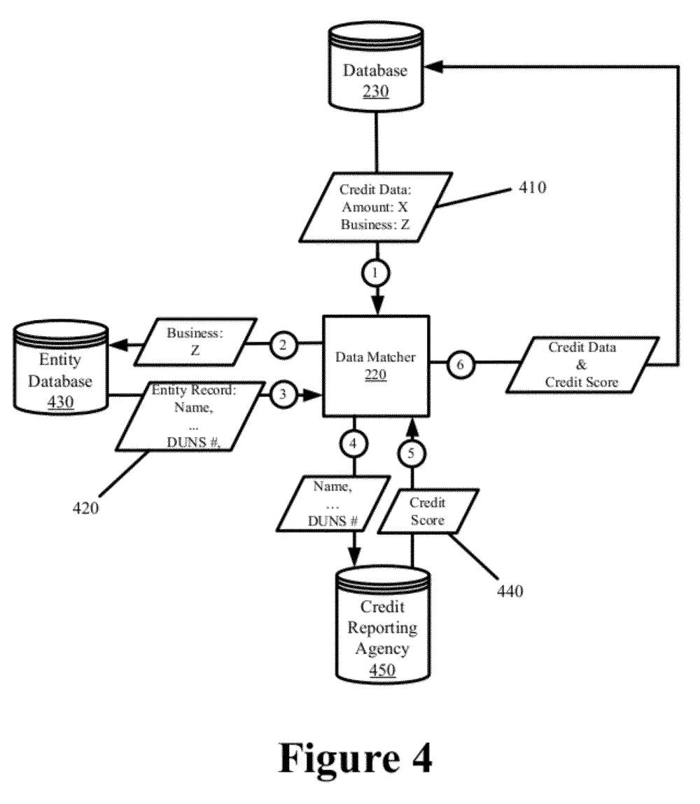

FIG. 4 conceptually illustrates the data matcher 220 matching aggregated credit origination data to a credit score in accordance with some embodiments. The data matcher 220 obtains the aggregated credit origination data 410 from the database 230. In this example, the identification component of the credit origination data 410 includes a business identifier that may be one or more of a business name, address, telephone number, DUNS number, etc. Using the business identifier, the data matcher 220 identifies entity record 420 from the entity database 430. The data matcher 220 then obtains the credit score 440 for the entity by passing entity identification information from the entity record 420 to a credit reporting agency 450. The data matcher 220 associates the credit score 440 with the aggregated credit origination data 410 and the associated data is stored back to the database 230.

In some embodiments, entity data from the entity record is also associated with the credit origination data when storing the credit origination data back to the database 230. In some such embodiments, the entity data is used to more accurately determine the credit that is available to a particular credit seeker. Specifically, the entity data provides different dimensions for filtering the presented credit availability. These dimensions include geographic location, industry, size of a business, years of operation, and experience level. It should be apparent that other dimensions contained within an entity record but that have not been explicitly enumerated herein are also applicable.

Based on the matching performed by the data matcher 220, the credit feedback loop system 120 is able to identify credit that various credit providers have recently made available to various credit seekers on the basis of credit scores and optionally other dimensions such as geographic location, industry, size of business, years of operation, and experience level as some examples. For example, the aggregated credit origination data identifies that within the past month, 75 businesses with a Paydex credit score of 90 have obtained lines of credit ranging from $20,000-$30,000 at an average of 6% interest and 28 businesses with a Paydex credit score of 40 have obtained lines of credit ranging from $7,000-$10,000 at an average of 7.5% interest. Then based on the matching performed by the data matcher 220, this credit origination data can be filtered on a specific dimension. For example, the credit origination data can be filtered by Standard Industrial Classification (SIC) codes in order to identify credit that is available to businesses operating in a particular industry. Continuing with the example above, the filtering may reveal that businesses with a Paydex credit score of 90 and with a first Standard Industrial Classification (SIC) code have obtained lines of credit ranging from $20,000-$23,000 at an average of 6.5% interest and businesses with a Paydex credit score of 90 and with a second SIC code have obtained lines of credit ranging from $25,000-$27,000 at an average of 6.25%.

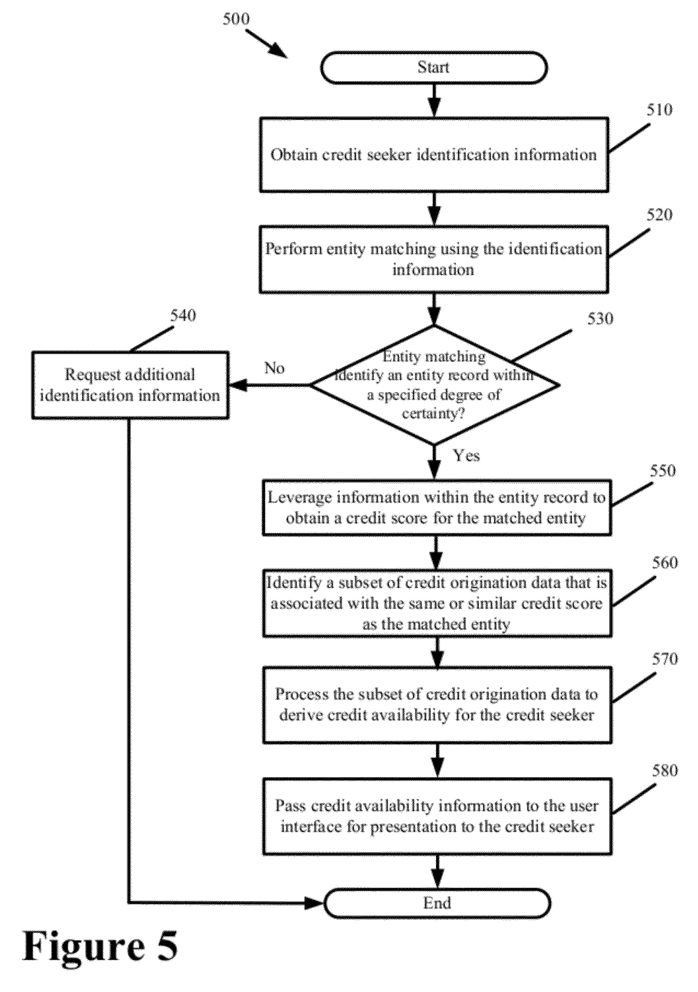

In some embodiments, the data matcher 220 performs a second matching operation when identifying the credit that is available to a new credit seeker. The second matching operation is performed to identify the credit score for a new credit seeker when the new credit seeker does not know or does not provide its credit score to the credit feedback loop system 120 when the credit feedback loop system 120 attempts to identify the credit that is available to the new credit seeker. FIG. 5 presents a process 500 performed by the data matcher 220 to identify available credit for a new credit seeker in accordance with some embodiments.

The process 500 begins by the data matcher 220 obtaining (at 510) credit seeker identification information. This information is provided by the credit seeker when accessing the credit feedback loop through the user interface 240. In some embodiments, the credit seeker first registers with the credit feedback loop system 120 in order to obtain access to the various features and functionality. As part of registration, the credit seeker provides identification information that may include one or more of a name, address, telephone number, URL, EIN, DUNS number, social security number, and credit score. In some cases, basic information such as a name or combination of name and address (i.e., physical street address or email address) is sufficient for registration. In other cases, registration involves the credit seeker completing a credit application form that is stored to the database. The information entered to this credit application form is submitted to different credit providers that the credit seeker selects to obtain credit from or is used to automatically populate credit application forms of different credit providers selected by the credit seeker.

As in process 300 above, the process 500 uses the identification information to perform (at 520) entity matching. The identification information identifies an entity record from an entity database with some degree of certainty. The process determines (at 530) whether the entity matching identifies an entity record within a specified degree of certainty. If not, the credit seeker is requested (at 540) to provide additional identification information. Otherwise, the process leverages (at 550) information within the identified entity record to obtain a credit score from one or more credit reporting agencies. Depending on the entity, this may include obtaining a FICO personal credit score or a Paydex business credit score.

Next, the process identifies (at 560) a subset of credit origination data from the database that is associated with the same or similar credit score as the matched entity. The subset of credit origination data is bounded to a range of credit scores that border the credit score for the entity. For example, when the entity is identified to have a Paydex credit score of 75, the data matcher identifies aggregated credit origination data that is associated with Paydex credit scores ranging between 73-77. In some embodiments, the identified subset is filtered according to one or more credit dimensions that are specified by the credit seeker, credit providers, or credit feedback loop system administrator. The filtering is an optional step, but can be used to provide more accurate credit availability information. For example, the identified subset of credit origination data may be filtered to include credit origination data that is associated with entities within a specified geographic region, entities that operate in a particular industry, entities with that have been in business for at least or at most a specified number of years, or entities with a minimum or maximum number of employees. As noted above, such filtering is performed using entity data that is associated with the aggregated credit origination data.

The data matcher processes (at 570) the identified and optionally filtered subset of credit origination data to derive credit availability for the credit seeker. In some embodiments, the processing involves computing averages, medians, or other numerical values for the subset of credit origination data. For example, the processing produces a high-end average line of credit and a low-end average line of credit that recent credit seekers with the same or similar credit score as the new credit seeker have obtained in the last month. In some embodiments, processing involves formatting the credit availability information for interactive presentation through the user interface, wherein the interactivity allows credit seekers to generally identify available credit, to select specific types of available credit, to specifically identify available credit at different credit providers, and to apply for credit from different credit providers directly through the user interface. The available credit at the different credit providers is identifiable based on the credit provider tags that are associated with each piece of credit origination data during the data aggregation process. The processed credit availability information is passed (at 580) to the user interface for presentation to the credit seeker and the process ends.

In some embodiments, checks are placed in the credit feedback loop system to ensure accurate reporting of credit availability information. In some such embodiments, a certain aggregate amount of credit origination data must be present before it is processed and used to derive available credit. For example, when at least 10 accounts of credit origination data are aggregated for a specific range of credit scores from a particular credit provider in a specified time period, then that data is used to identify available credit at that particular credit provider for credit seeker with a credit score that is within the specific range of credit scores. However, when fewer than 10 accounts of credit origination data are aggregated from a particular credit provider, then credit availability data for that credit provider is not presented to credit seekers. It should be apparent that the numbers in the foregoing example are illustrative and not meant to be restrictive. Different embodiments of the credit feedback loop system may set different thresholds for the amount of credit origination data that needs to be aggregated before it is used in the derivation of credit availability.

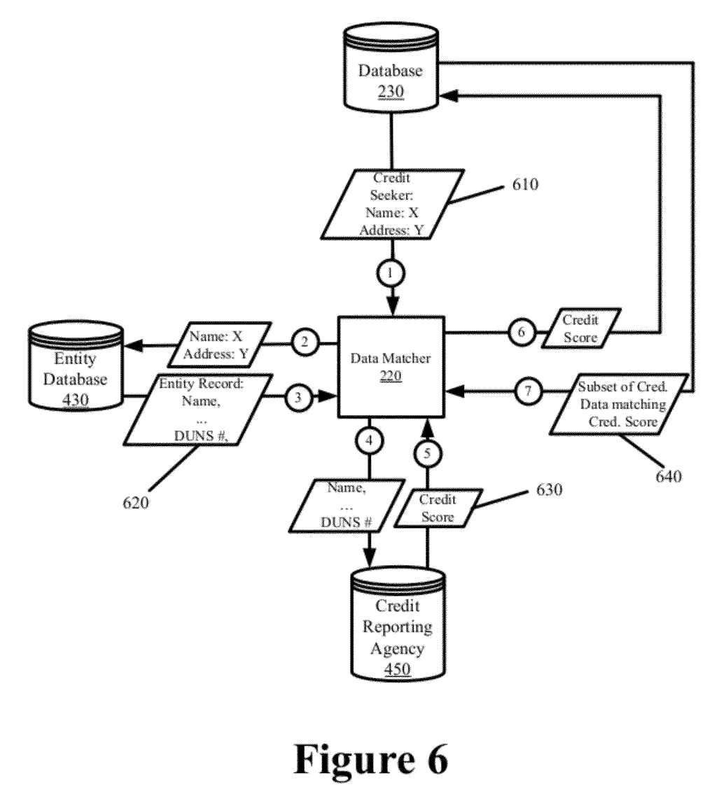

FIG. 6 conceptually illustrates the data matcher 220 identifying available credit for a new credit seeker in accordance with some embodiments. The data matcher 220 obtains identification information 610 about the new credit seeker from the database 230, though this information can come directly from the entity when the entity interacts with the user interface. The identification information 610 is used to identify entity record 620 from the entity database 430. The data matcher 220 then obtains the credit score 630 for the entity by passing entity identification information from the entity record 420 to a credit reporting agency 450. The data matcher 220 passes the credit score 630 back to the database 230 in order to identify a subset of credit origination data 640 that is associated with the credit score 630. The subset of credit origination data 640 is then processed by the data matcher 220 to identify available credit for the new credit seeker which is subsequently presented to the new credit seeker through the user interface.

C. User Interface

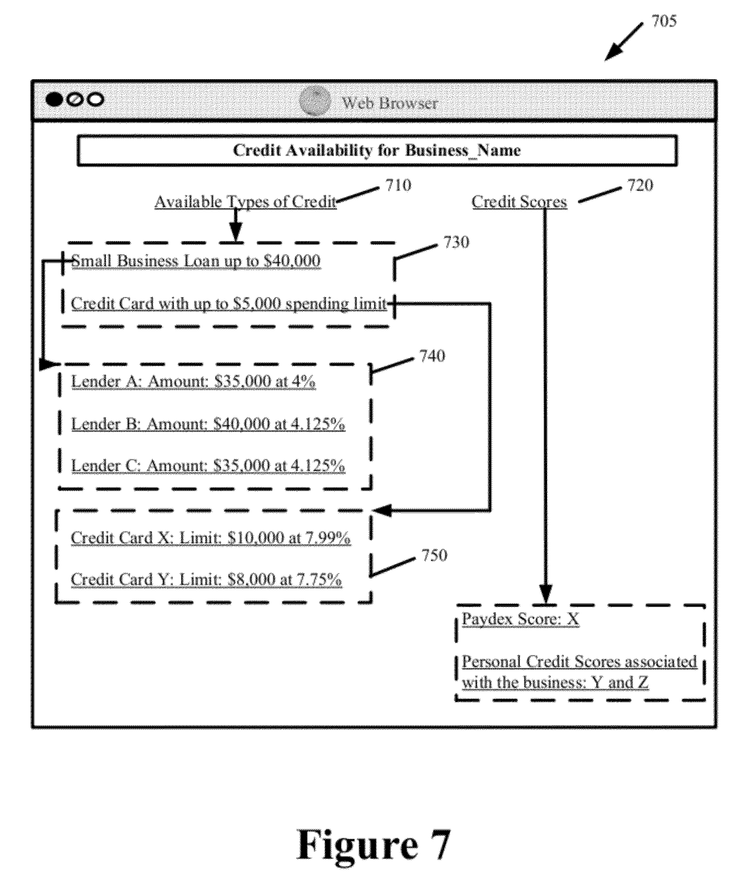

FIG. 7 provides an exemplary user interface 705 for interactively presenting credit that is available to a particular credit seeker in accordance with some embodiments. The user interface 705 is accessible by any network enabled device. Specifically, the interface 705 may be accessed by entering an identifying Uniform Resource Identifier (URI) to point to the user interface 705 in a web browser application or by executing a specific standalone application that accesses the interface 705.

The user interface 705 presents the credit seeker with an initial interactive screen (not shown) in which the credit seeker provides its identification information. This identification information initiates operation of the credit feedback loop system. Specifically, this identification information is used by the data matcher to identify an entity record to identify the credit seeker and to obtain a credit score for the credit seeker if one was not provided as part of the identification information. Then, the data matcher identifies the credit origination data that has recently been extended to credit seekers with similar qualifications (e.g., credit scores) as the current credit seeker and that credit origination data is presented through the user interface 705 such that the credit seeker can view the credit that is available to it. In some embodiments, the identification information is provided as a part of a registration process whereby the credit seeker creates an account with a username and password and populates the account with the identification information. However, the ease of use of the credit feedback loop system is the minimal information that the credit seeker needs to provide in order to view the accurate measures of the credit that are available to the credit seeker. Accordingly, the registration process may be simplified such that the credit seeker need only provide its credit score as the identification information, if it is known, or instead provide other basic information. In some embodiments, the basic identification information may include one of the full name, business name, telephone number, address, etc. of the credit seeker when that information is sufficient to uniquely identify the credit seeker. In some instances, this information may not be enough to uniquely identify the credit seeker. Therefore, the credit seeker is requested to provide at least one additional piece of identification information where two or more items of basic identification information (e.g., full name and telephone number) are sufficient to uniquely identify the credit seeker. To reiterate, the benefit and ease of use of the credit feedback loop system stems from the minimal information that is required from the credit seeker and from the accuracy and relevance of the credit availability information that is provided in return. The credit seeker need not provide confidential information to the credit feedback loop in order to obtain the credit availability information, whereas the credit seeker would ordinarily only gain access to this credit availability information after filling out a credit application in which the credit seeker provides its social security number, financial information (e.g., bank accounts, tax returns, revenue, etc.), credit history, or other information that is confidential or not readily available.

In FIG. 7, the user interface 705 presents credit that is available to a particular credit seeker based on previously submitted credit seeker identification information. As shown, the user interface 705 provides navigation links 710 and 720 for accessing different credit related information. Link 710 is used to identify the different types of credit that are available to the credit seeker. When link 710 is invoked, the user interface displays interactive links 730 that identify types of credit that are available to the credit seeker (e.g., mortgages, credit cards, personal lines of credit, etc.). Link 720 is used to identify the credit scores of the credit seeker. In some embodiments, access to some or all of the information associated with links 710 and 720 is restricted to credit seekers that have paid an access fee, registration fee, or that have enrolled in a subscription package. In some other embodiments, access to the information associated with links 710 and 720 is freely provided and the credit feedback loop system generates revenue when a credit seeker is referred to a particular credit provider from whom the credit seeker obtains some form of credit as a result of the referral.

In this figure, the interactive links 730 identify that the credit seeker has available credit in the form of a small business loan as well as a business credit card. Each of the links 730 is also invocable such that invoking the small business loan link causes the user interface to display small business loan amounts and terms that can be obtained from each one of three different credit providers 740 and invoking the credit card link causes the user interface to display limits and terms for credit cards that can be obtained from each one of two different credit providers 750. It should be noted that the credit providers within 740 and 750 are presented as a result of the credit providers participating in the credit feedback loop system and as a result of the credit providers providing sufficient credit origination data from which credit availability can be determined. Specifically, credit origination data that is aggregated from these credit providers (see 740 and 750) is tagged with an identifier that identifies the data as coming from the credit providers. Therefore, when the data is retrieved and used to present available credit to a credit seeker, the available credit can be presented on a per credit provider basis.

Each of the links 740 and 750 is also invocable. Invoking any of the links of 740 or 750 refers the credit seeker to a credit provider whose available credit information is presented in the invoked link. A referral may include redirecting or forwarding the credit seeker to a site of the selected credit provider. A referral may also include providing the selected credit provider contact information of the credit seeker so that the selected credit provider can contact the credit seeker. A referral may also include providing the credit seeker with contact information of the selected credit provider. A referral may also include automatically submitting a credit application on behalf of the credit seeker to the selected credit provider. In some embodiments, when a credit seeker is referred to a credit provider and the credit seeker successfully obtains credit from the credit provider as a result of the referral, the credit provider provides a referral fee to the credit feedback loop system. In some embodiments, the credit seeker may have to complete a credit application form at the credit provider site in order to apply for and obtain credit. However, by virtue of the credit availability information that is provided by the credit feedback loop system, the credit seeker will know before applying, what types of credit and how much credit the particular credit provider will extend to the credit seeker. In some embodiments, the credit feedback loop system automatically populates the credit application form based on registration information provided by the credit seeker. In still some other embodiments, a credit application form is automatically sent from the credit feedback loop system to a selected credit provider and the credit provider instantaneously approves or declines the application. Once approved, the amount and terms of the obtained credit are presented to the user through the user interface and the credit feedback loop system aggregates the credit origination data for use in deriving the available credit for subsequent credit seekers.

In some embodiments, the user interface provides various tools for filtering the credit availability information based on different credit dimensions. These tools may include sliders, drop down boxes, or text entry boxes. Additionally, the filtering may be automatically specified by the credit feedback loop system administrator or different filtering may be specified by different credit providers.

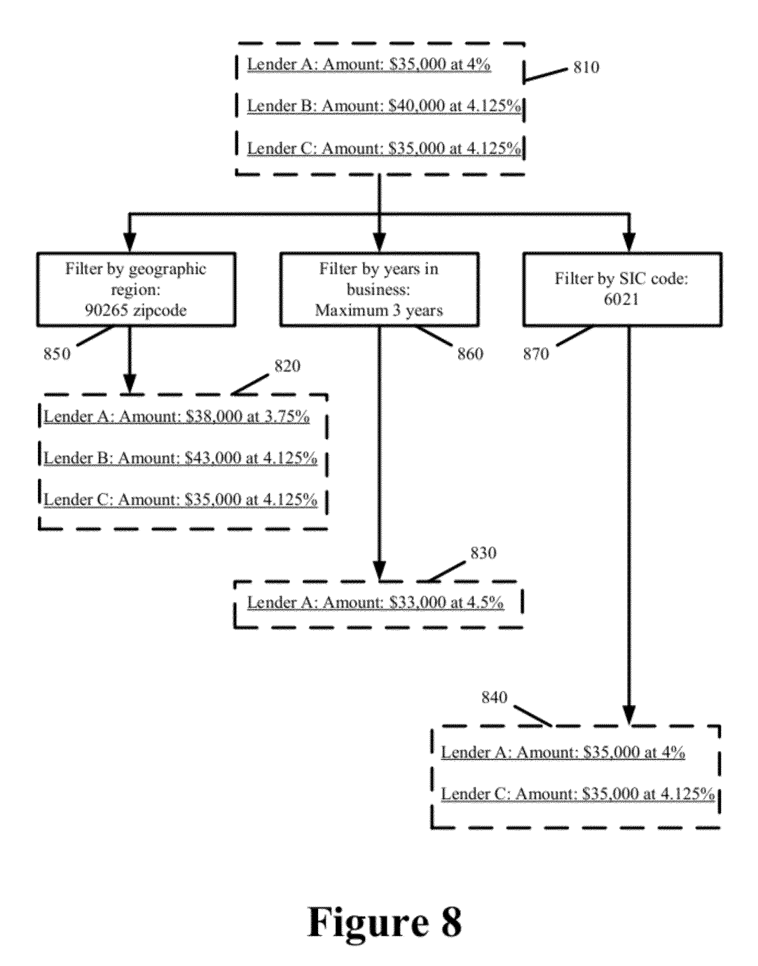

FIG. 8 conceptually illustrates how different credit dimensions can be used to filter the credit availability data that is presented in the user interface in accordance with some embodiments. The unfiltered credit availability is shown at 810 and filtered credit availability is shown at 820, 830, and 840 as a result of filters 850, 860, and 870.

The unfiltered credit availability 810 identifies a subset of the aggregated credit origination data based solely on a particular credit score or range of credit scores. This may include the aggregated credit origination data for other entities having the same or similar credit score as the credit seeker seeking to identify the credit that is available to it. Alternatively, this may include the aggregated credit origination data for a credit score that is specified by a credit seeker, even though the credit seeker has a different actual credit score. This may be useful when the credit seeker wants to determine how much additional credit would be available to it if its credit score was to improve or how much lesser credit would be available to it if is credit score was to degrade.

The filter 850 focuses the credit availability based on a specified geographic region. The geographic region may be specified by the credit seeker or may be automatically specified by the credit feedback loop system based on the geographic region that is specified for a credit seeker upon identifying the entity record for that credit seeker. For example, when the credit seeker is an individual and the entity record identified for the credit seeker contains an address at which the credit seeker resides, the credit feedback loop system automatically applies that address as the specified geographic region for the filter 850. In so doing, the filter 850 identifies credit that is available to the credit seeker in the region closest to where the credit seeker resides. In the example illustrated by FIG. 8, credit providers are willing to extend greater amounts of credit to entities that are associated with the specified geographic region than when no geographic filter is specified.

The filter 860 focuses the credit availability to include credit that is available to credit seekers (1) having a particular credit score or range of credit scores and (2) that have been extended to other entities operating for less than three years. Accordingly, the filter 860 is a temporal filter. In some embodiments, the temporal filter is specified with a maximum time limit and a minimum time limit or an upper bound and a lower bound. As a result of applying the filter 860, the resulting filtered credit availability data 830 shows that credit providers are less inclined to extend credit to a business that has been operating for less than three years than if the filter 860 was not applied. Additionally, the available credit is subject to worse terms. The filter 860 can thus be used to restrict the presented available credit to better align with the qualifications of the credit seeker along a temporal dimension.

The filter 870 focuses the credit availability to include credit that is available to a particular credit seeker (1) having a particular credit score or range of credit scores and (2) that have been extended to other entities operating in the same line of business as the particular credit seeker. As shown, the filter 870 is specified using a SIC code, though other values can be specified to identify the line of business or a series of checkboxes or selection dialogs may be presented to specify the line of business. Accordingly, the filter 870 is a field of use or operational filter. The value for the filter 870 may be specified by the credit seeker or may be automatically specified by the credit feedback loop system based on a SIC code or other value that is specified for a credit seeker upon identifying the entity record for that credit seeker.

These examples illustrate the use of filters to improve the accuracy for the reported credit that is available to a particular credit seeker. Any one or more filters may be applied independently or in combination to derive filtered credit availability information. Additionally, it should be apparent to one of ordinary skill in the art that additional filters may be utilized in addition to or instead of the above enumerated filters. For example, filters may be used to identify specific types of available credit. These filters are intended to better restrict the aggregated credit origination data such that it is more applicable and better representative of the credit seeker.

The above illustrates various filters that the credit seekers can set in the credit feedback loop system. In some embodiments, the credit feedback loop system also allows credit providers participating in the feedback loop system to set one or more filters. The filters set by a credit provider can be used to specify minimum qualifications for credit seekers that the credit feedback loop system refers to that credit provider. Additionally or alternatively, the filters set by a credit provider can be used to specify minimum qualifications for credit seekers before credit availability information is displayed by the credit feedback loop system to those credit seekers.

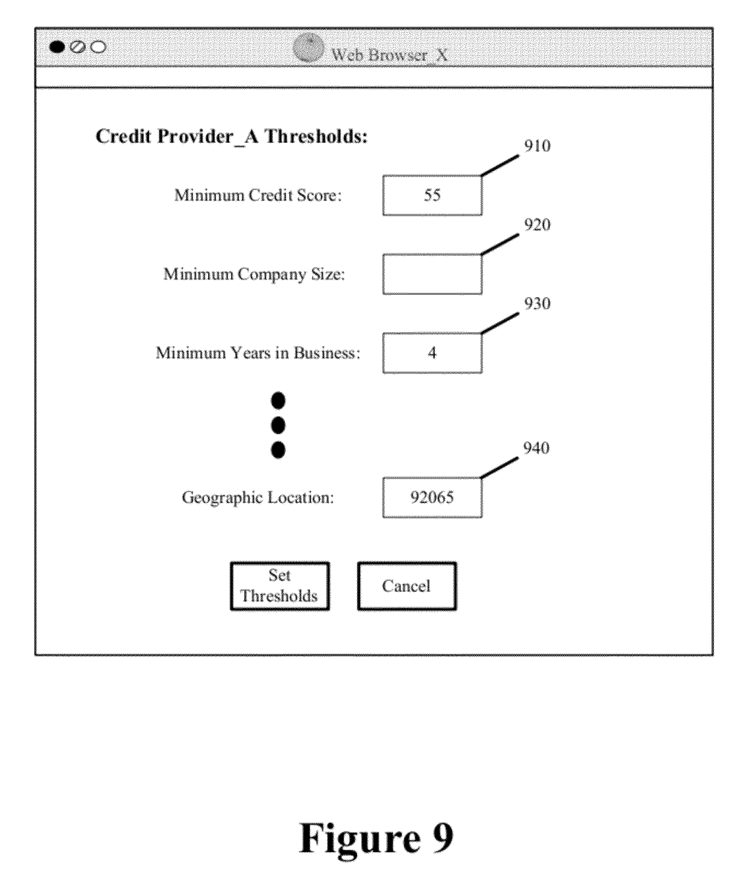

To specify one or more of these filters, a participating credit provider registers with the credit feedback loop system. Once registered, the credit provider can specify the different filters using the user interface. FIG. 9 illustrates a user interface with which a credit provider can set filters in accordance with some embodiments.

As shown, a credit provider can set a filter specifying one or more of a minimum credit score 910, a minimum size 920 (e.g., number of employees, minimum revenue, etc.), minimum years in business 930, geographic location 940, etc. for a credit seeker that can be referred to the credit provider or for a credit seeker that is able to view credit that has been made available by that credit provider. Filters that are specified by a particular credit provider are retained within the database. These filters are then used by the user interface when presenting available credit information to a credit seeker. For instance, whenever credit origination data is found for a particular credit seeker in response to a query of a particular credit seeker, the credit feedback loop system will identify if the particular credit seeker has set any filters. If one or more filters have been set by the particular credit seeker, the credit feedback loop system executes the filters to determine if the credit seeker meets or satisfies the qualifications set in the filters. In some embodiments, if the credit seeker does not satisfy the qualifications set in the filters, the credit seeker is not be presented with the credit origination data that is aggregated for that particular credit provider. In some embodiments, if the credit seeker does not satisfy the qualifications set in the filters, the credit seeker is presented with the credit origination data aggregated for that particular credit provider although the identification of the particular credit provider is hidden from the particular credit seeker to prevent the particular credit seeker from being referred to that particular credit provider. In this manner, credit providers can filter the credit seekers that they would like to extend credit to. This assists the credit provider in limiting its risk exposure and in improving its profitability.

Some embodiments of the credit feedback loop system include failsafes such that credit availability information can be reported to credit seekers even when entity matching cannot be performed for the credit seeker. These failsafes apply when the credit seeker is, for example, a newly established business that does not have a credit score. In some such embodiments, the credit feedback loop system produces credit availability indices. Each index includes available credit as a first parameter or first axis and credit scores as a second parameter or second axis. Each index can be filtered using zero or more credit dimensions. The credit availability indices are generalized in the sense that they do not convey credit that is available to a particular entity. Rather, the credit availability indices identify the credit that would be available to an entity if that entity had a particular credit score.

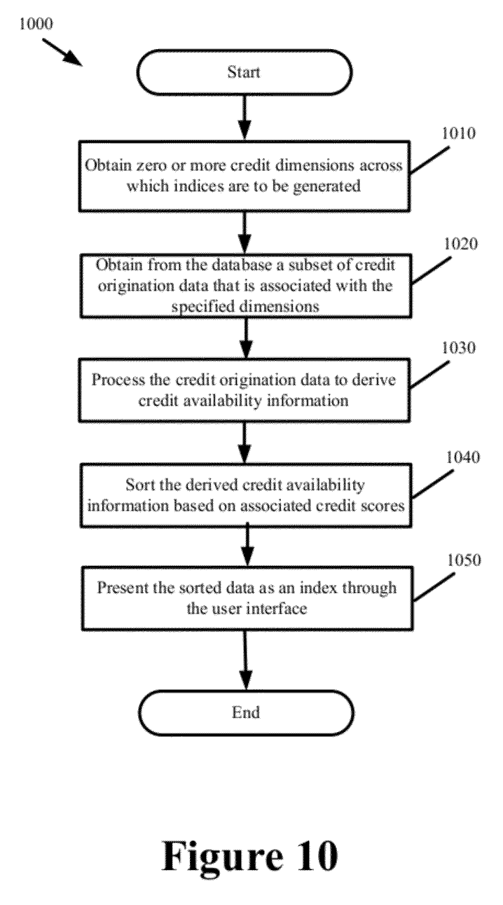

FIG. 10 presents a process 1000 for producing credit indices in accordance with some embodiments. The process 1000 begins by obtaining (at 1010) zero or more credit dimensions across which one or more indices are to be generated. When no credit dimensions are specified, the resulting indices generally present credit that is available solely based on a credit score. When one or more credit dimensions are specified, the resulting indices are filtered to present credit that is available for credit seekers with different credit scores that satisfy the specified dimensions. The process 1000 will be described with reference to a single specified credit dimension.

The process obtains (at 1020) from the database a subset of credit origination data that is associated with the specified dimension(s). For example, when the credit dimension specifies the city of Los Angeles as the geographic region, the process obtains all credit origination data for credit seekers that successfully obtained credit in the city of Los Angeles over a particular time period (e.g., last month). The process then processes (at 1030) the obtained credit origination data to derive credit availability information and the derived credit availability information is sorted (at 1040) based on associated credit scores. The sorted data is presented (at 1050) to credit seeker through the user interface.

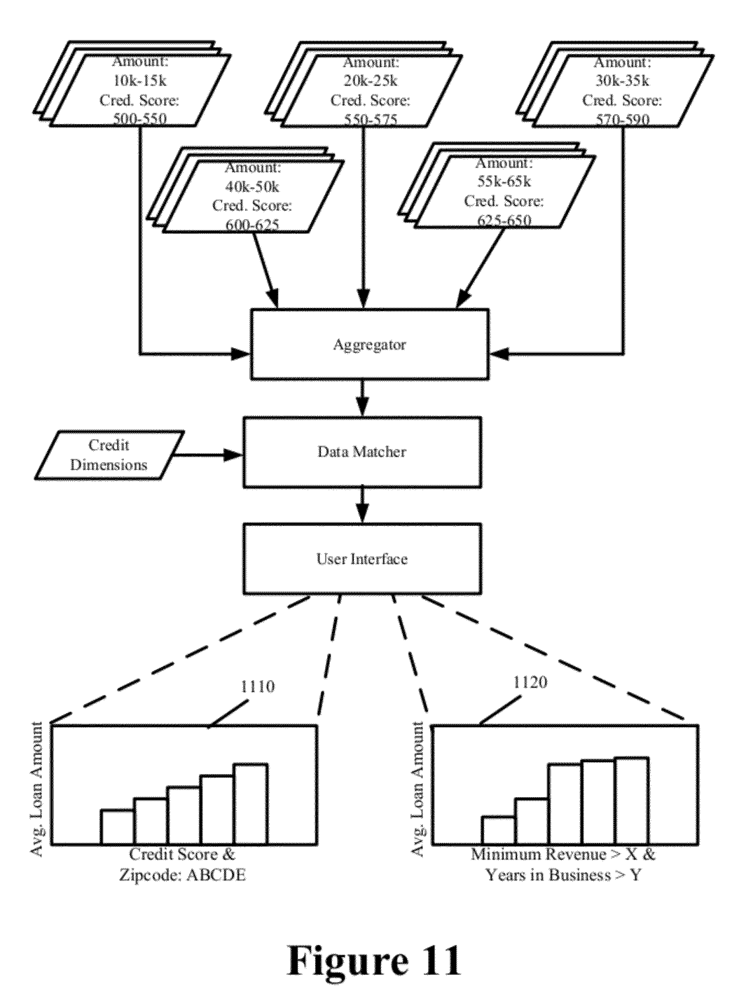

FIG. 11 conceptually illustrates performing the process 1000 to derive a first credit availability index 1110 and a second credit availability index 1120 in accordance with some embodiments. The first credit availability index 1110 is filtered based on a specified geographic zipcode. Accordingly, the first credit availability index 1110 presents, for a range of credit scores, the credit that is available to a credit seeker operating in the specified zipcode. The second credit availability index 1120 is filtered based a combination of two credit dimensions: minimum yearly revenue and minimum number of years in operation. Accordingly, the second credit availability index 1120 presents, for a range of credit scores, the credit that is available to a credit seeker that generates at least the specified minimum yearly revenue and that has been in operation for at least the specified number of years.

The credit dimensions that are used to filter the aggregated credit origination data may be included as part of the aggregated credit origination data. In some other embodiments, the aggregated credit origination data may include terms of the extended credit and an identifier for identifying who the credit seeker that obtained the credit is. Then, the credit feedback loop system can use the identifier to query the entity database in order to retrieve a matching entity record that contains additional information about the credit seeker, wherein the additional information is used for filtering along the specified credit dimensions. In some other embodiments, the credit feedback loop system automatically populates the credit dimensions for aggregated credit origination data based on where the credit origination data is aggregated from. For example, when the credit feedback loop system aggregates credit origination data from a particular bank branch, the credit feedback loop system can associate the geographic identifier (e.g., zipcode) of that particular bank branch with the aggregated credit origination data.

Using the credit availability indices, a credit seeker can gain a general sense of the credit market while also appreciating what changes have to be made in order to be able to obtain a desired amount of credit. Credit seekers may specify credit dimensions for the indices through the user interface.

III. Computer System

Many of the above-described processes and modules are implemented as software processes that are specified as a set of instructions recorded on a non-transitory computer-readable storage medium (also referred to as computer-readable medium). When these instructions are executed by one or more computational element(s) (such as processors or other computational elements like ASICs and FPGAs), they cause the computational element(s) to perform the actions indicated in the instructions. Computer and computer system are meant in their broadest sense, and can include any electronic device with a processor including cellular telephones, smartphones, portable digital assistants, tablet devices, laptops, and netbooks. Examples of computer-readable media include, but are not limited to, CD-ROMs, flash drives, RAM chips, hard drives, EPROMs, etc.

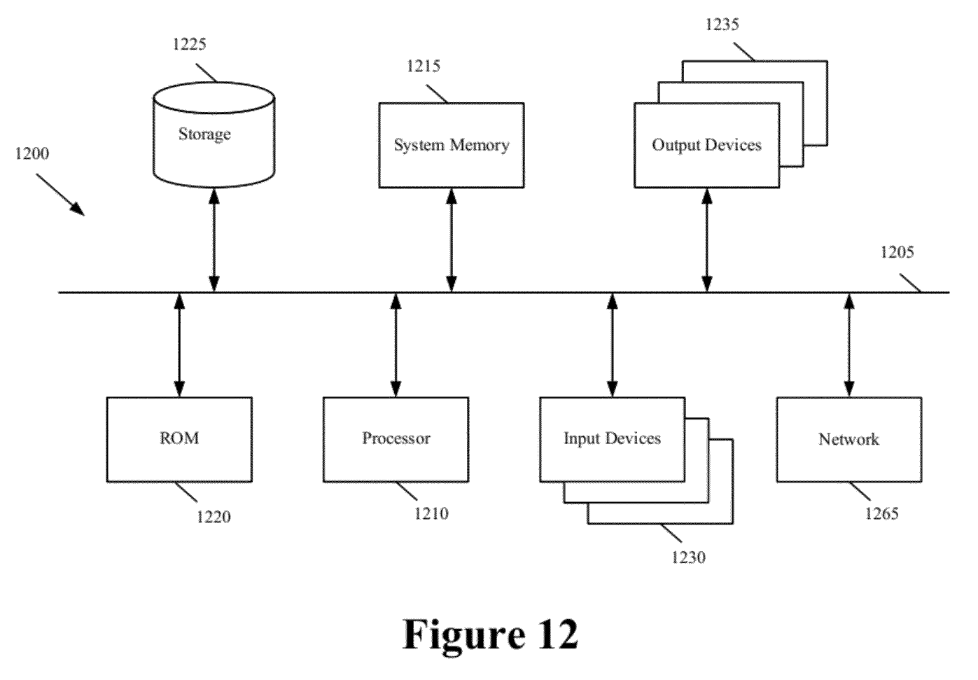

FIG. 12 illustrates a computer system with which some embodiments are implemented. Such a computer system includes various types of computer-readable mediums and interfaces for various other types of computer-readable mediums that implement the various processes, modules, and engines described above (e.g., data aggregator, data matcher, etc.). Computer system 1200 includes a bus 1205, a processor 1210, a system memory 1215, a read-only memory 1220, a permanent storage device 1225, input devices 1230, and output devices 1235.

The bus 1205 collectively represents all system, peripheral, and chipset buses that communicatively connect the numerous internal devices of the computer system 1200. For instance, the bus 1205 communicatively connects the processor 1210 with the read-only memory 1220, the system memory 1215, and the permanent storage device 1225. From these various memory units, the processor 1210 retrieves instructions to execute and data to process in order to execute the processes of the invention. The processor 1210 is a processing device such as a central processing unit, integrated circuit, graphical processing unit, etc.

The read-only-memory (ROM) 1220 stores static data and instructions that are needed by the processor 1210 and other modules of the computer system. The permanent storage device 1225, on the other hand, is a read-and-write memory device. This device is a non-volatile memory unit that stores instructions and data even when the computer system 1200 is off. Some embodiments of the invention use a mass-storage device (such as a magnetic or optical disk and its corresponding disk drive) as the permanent storage device 1225.

Other embodiments use a removable storage device (such as a flash drive) as the permanent storage device Like the permanent storage device 1225, the system memory 1215 is a read-and-write memory device. However, unlike storage device 1225, the system memory is a volatile read-and-write memory, such as random access memory (RAM). The system memory stores some of the instructions and data that the processor needs at runtime. In some embodiments, the processes are stored in the system memory 1215, the permanent storage device 1225, and/or the read-only memory 1220.

The bus 1205 also connects to the input and output devices 1230 and 1235. The input devices enable the user to communicate information and select commands to the computer system. The input devices 1230 include any of a capacitive touchscreen, resistive touchscreen, any other touchscreen technology, a trackpad that is part of the computing system 1200 or attached as a peripheral, a set of touch sensitive buttons or touch sensitive keys that are used to provide inputs to the computing system 1200, or any other touch sensing hardware that detects multiple touches and that is coupled to the computing system 1200 or is attached as a peripheral. The input devices 1230 also include alphanumeric keypads (including physical keyboards and touchscreen keyboards), pointing devices (also called “cursor control devices”). The input devices 1230 also include audio input devices (e.g., microphones, MIDI musical instruments, etc.). The output devices 1235 display images generated by the computer system. The output devices include printers and display devices, such as cathode ray tubes (CRT) or liquid crystal displays (LCD).

Finally, as shown in FIG. 12, bus 1205 also couples computer 1200 to a network 1265 through a network adapter (not shown). In this manner, the computer can be a part of a network of computers such as a local area network (“LAN”), a wide area network (“WAN”), or an Intranet, or a network of networks, such as the Internet. For example, the computer 1200 may be coupled to a web server (network 1265) so that a web browser executing on the computer 1200 can interact with the web server as a user interacts with a GUI that operates in the web browser.

As mentioned above, the computer system 1200 may include one or more of a variety of different computer-readable media. Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, ZIP® disks, read-only and recordable blu-ray discs, any other optical or magnetic media, and floppy disks.

While the invention has been described with reference to numerous specific details, one of ordinary skill in the art will recognize that the invention can be embodied in other specific forms without departing from the spirit of the invention. Thus, one of ordinary skill in the art would understand that the invention is not to be limited by the foregoing illustrative details, but rather is to be defined by the appended claims.

We claim:

1. A computer-implemented method for facilitating the acquisition of credit by accurately presenting credit that is available to a particular credit seeker from a plurality of credit providers without the particular credit seeker preparing a credit application for submission to any of the plurality of credit providers, the computer-implemented method comprising:
aggregating credit origination data from the plurality of credit providers, the credit origination data representing amounts and terms of credit that the plurality of credit providers have extended to a plurality of credit seekers with varying credit scores, wherein the plurality of credit seekers excludes the particular credit seeker;
receiving identification information for the particular credit seeker;
obtaining a credit score for the particular credit seeker based on the received identification information;
from the aggregated credit origination data, extracting from the aggregated credit origination data, a subset of credit origination data that has been extended to a subset of credit seekers from the plurality of credit seekers with credit scores within an upper bound and a lower bound of the credit score obtained for the particular credit seeker;
identifying amounts and terms of credit that have been extended to the subset of credit seekers by processing the subset of credit origination data; and
presenting the amounts and terms of credit from the subset of credit origination data as credit that is available to the particular credit seeker.

2. The computer-implemented method of claim 1, wherein presenting the amounts and terms of credit comprises presenting on a per credit provider basis, the credit origination data from the subset of aggregated credit origination data that represents credit extended by said credit provider.

3. The computer-implemented method of claim 2 further comprising receiving a selection identifying a particular credit provider of the plurality of credit providers.

4. The computer-implemented method of claim 3 further comprising referring the particular credit seeker to the particular credit provider to facilitate the particular credit seeker's acquisition of credit from the particular credit provider.

5. The computer-implemented method of claim 3 further comprising populating a credit application of the selected particular credit provider based on the identification information for the particular credit seeker.

6. The computer-implemented method of claim 3 further comprising submitting a credit application on behalf of the particular credit seeker to the selected particular credit provider using the received identification information.

7. The computer-implemented method of claim 1 further comprising receiving a filter defined by the particular credit seeker that restricts the subset of credit origination data that is extracted from the aggregated credit origination data.

8. The computer-implemented method of claim 7 further comprising filtering the subset of credit origination data based on the received filter, said filtering restricting the subset of credit origination data that is extracted from the aggregated credit origination data to at least one of a particular geographic region and a particular industry.

9. The computer-implemented method of claim 1 further comprising receiving a filter defined by a particular credit provider of the plurality of credit providers that restricts presentation of credit origination data that the particular credit provider has extended.

10. The computer-implemented method of claim 9 further comprising filtering presentation of the subset of origination data based on the received filter, said filtering restricting presentation of the credit origination data that is extended by the particular credit provider when the particular credit seeker does not satisfy a condition set by the particular credit provider.

11. The computer-implemented method of claim 1 further comprising setting the upper bound and the lower bound for the credit score of the particular credit seeker.

12. The computer-implemented method of claim 1 further comprising identifying a set of the plurality of credit seekers having credit scores within the upper bound and the lower bound of the credit score of the particular credit seeker.

13. A computer-implemented method for facilitating the acquisition of credit by accurately presenting credit that is available to a particular credit seeker from a plurality of credit providers without the particular credit seeker preparing a credit application for submission to any of the plurality of credit providers, the computer-implemented method comprising:
aggregating from the plurality of credit providers, amounts and terms of credit that a plurality of credit seekers with varying credit scores have successfully obtained from the plurality of credit providers, wherein the plurality of credit seekers excludes the particular credit seeker;
providing a first interface comprising at least one input field for the particular credit seeker to enter identification information;
identifying a credit score for the particular credit seeker based on the identification information; and
providing a second interface comprising a plurality of selectable links, each selectable link presenting amounts and terms of credit that a credit provider of the plurality of credit providers has extended to at least one credit seeker having a credit score within an upper bound and a lower bound of the identified credit score of the particular credit seeker, wherein selection of a link of the plurality of selectable links directs the particular credit seeker to a credit provider whose amounts and terms of extended credit are presented in association with that link, thereby enabling the particular credit seeker to acquire similar amounts and terms of credit from that credit provider as successfully obtained by a prior credit seeker having a credit score within the upper bound and the lower bound of the identified credit score of the particular credit seeker.

14. The computer-implemented method of claim 13 further comprising passing the particular credit seeker as a lead to a particular credit provider when the particular credit seeker selects a link presenting amounts and terms of credit that the particular credit provider has extended.

15. The computer-implemented method of claim 13 further comprising automatically populating a credit application of a particular credit provider based on the identification information and passing said credit application to the particular credit provider when the particular credit seeker selects a link that is associated with that particular credit provider.

16. The computer-implemented method of claim 13 further comprising providing a third interface for the particular credit seeker to specify a filter that restricts the credit that is presented in the second interface based on at least one of a particular geographic region and a particular industry.

17. The computer-implemented method of claim 13 further comprising providing a third interface for any particular credit provider of the plurality of credit providers to define a filter that restricts presentation of the amounts and terms of credit that the particular credit provider has extended.

18. The computer-implemented method of claim 13 further comprising providing a third interface for submission of an amount and term of credit that a credit seeker has recently obtained, said submission for inclusion with the aggregating of the amounts and terms of credit.

19. The computer-implemented method of claim 13 further comprising sorting on a per credit provider basis, the amounts and terms of credit that at least one credit seeker of the plurality of credit seekers has successfully obtained from each credit provider of the plurality of credit providers.

20. A non-transitory computer-readable storage medium with an executable program stored thereon, wherein said program instructs a microprocessor to perform sets of instructions for:
aggregating credit origination data identifying amounts and terms of credit that a plurality of credit providers have extended to a plurality of credit seekers based on credit scores of the plurality of credit providers, wherein the plurality of credit providers comprises at least a first credit provider and a second credit provider;
obtaining a credit score for a particular credit seeker seeking its credit availability; and
prequalifying the particular credit seeker to obtain credit from at least one the plurality of credit providers, said prequalifying comprising:
extracting amounts and terms of credit that the first credit provider has extended to a first subset of the plurality of credit seekers having credit scores within an upper bound and a lower bound of the credit score of the particular credit seeker;
extracting amounts and terms of credit that the second credit provider has extended to a second subset of the plurality of credit seekers having credit scores within an upper bound and a lower bound of the credit score of the particular credit seeker;
presenting the extracted amounts and terms of credit extended by the first credit provider to the first subset of credit seekers as a first selectable link; and
presenting the extracted amounts and terms of credit extended by the second credit provider to the second subset of credit seekers as a second selectable link.

21. The non-transitory computer-readable storage medium of claim 20, wherein said program further comprises a set of instructions for (i) submitting on behalf of the particular credit seeker, a request for similar amounts and terms of credit as extended by the first credit provider to the first subset of credit seekers when the first selectable link is selected and (ii) submitting on behalf of the particular credit seeker, a request for similar amounts and terms of credit as extended by the second credit provider to the second subset of credit seekers when the second selectable link is selected.

22. The non-transitory computer-readable storage medium of claim 21, wherein said program further comprises a set of instructions for receiving a selection of one of the first selectable link and the second selectable link.
